(19) United States
(12) Patent Application Publication
(10) Pub. No.: US 2009/0310133 A1
(43) Pub. Date: Dec. 17, 2009

(54) METHOD FOR DESIGNING LIGHT TRANSMISSION DEVICE, OPTICAL ELEMENT AND SENSOR

(75) Inventors: Masaya Ogino, Kawasaki-shi (JP); Tomohiro Yamada, Yokohama-shi (JP); Satoru Nishiuma, Kawasaki-shi (JP); Natsuhiko Mizutani, Tokyo (JP); Ryo Kuroda, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/158,147

(22) PCT Filed: Feb. 26, 2007
(86) PCT No.: PCT/JP2007/054108

§ 371 Date: Jun. 19, 2008

(30) Foreign Application Priority Data
Feb. 28, 2006 (JP) 2006-052157
Feb. 28, 2006 (JP) 2006-052226

(51) Int. Cl. G01J 3/04; G02B 5/00; G02B 5/20; G02B 5/30

(52) U.S. Cl. 356/310; 359/894; 359/885; 359/485

(57) ABSTRACT

The present invention provides a method for designing a light transmission device, which adjusts a wavelength region of a spectrum of transmitted light without expanding a width of a transmission spectrum and without lowering the transmittance. The method for designing a light transmission device having a metal thin film, and a rectangular aperture which is formed in a plane of the metal thin film, has a long side and a short side and makes light pass therethrough, wherein the short side has a dimension smaller than a wavelength of incident light, and the long side is determined to have such a dimension that a peak wavelength at which the transmittance of light passing through the rectangular aperture is maximal can be a predetermined value.

### TECHNICAL FIELD

The present invention relates to a method for designing a light transmission device, an optical element and a sensor.

### BACKGROUND ART

Conventionally, a method of making use of the absorption of a coloring matter or a method of making use of the Bragg reflection of a dielectric multilayer has been used in a device for filtering an electromagnetic wave.

On the other hand, it has been revealed in recent years that light abnormally passes through a circular aperture formed in a metal thin film caused by localized plasmon resonance, so that the wavelength can be selected and light can be condensed, as is disclosed in Japanese Patent No. 3,008,931.

When light passes through a circular or square aperture formed in a metal thin film, the transmission spectrum changes depending on an aperture size (or side length).

However, there has been a problem that when the aperture size is enlarged, the width of the transmission spectrum unavoidably becomes broad because light quantity transmitting without being affected by plasmon increases, and when the aperture size is reduced, a transmittance unavoidably decreases.

For this reason, a method is demanded which can adjust a wavelength region of a spectrum of transmitted light, without enlarging a transmission spectrum width and without lowering transmittance.

In addition, a biosensor has been increasingly demanded in fields of diagnosis in medical care and inspection for food in recent years, and it has been demanded to develop a biosensor which is small, is inexpensive and can sense objects at a high speed.

For this purpose, a biosensor has been developed which detects objects by using an electrochemical technique with the use of an electrode or an FET.

In addition, such a sensor is demanded as is capable of being further integrated, decreasing its cost, and being used under any measuring environment. For this reason, a biosensor is regarded as promising which uses a surface plasmon resonance phenomenon as a transducer.

This is a biosensor which detects whether a substance has been adsorbed onto the biosensor or not, for instance, whether an antigen is adsorbed onto the biosensor through an antigen-antibody reaction, by using surface plasmon resonance generated on a metal thin film provided on the surface of a total reflection type prism.

Japanese Patent Application Laid-Open No. 2003-270132 discloses a chemical sensor device for measuring a refractive index by making use of the properties of surface plasmon.

A sensor element used here senses an object based on one peak wavelength of transmitted light.

An aperture array on a metal thin film has received attention merely because transmission intensity increases due to localized plasmon resonance. On the other hand, the aperture array has characteristics like a filter, but has not always had high S/N (signal-to-noise ratio).

When an aperture array is applied to a refractive index sensor, it is advantageous for the aperture array to have a filter function for a plurality of wavelength regions in order to increase measurement accuracy, but a sensor having such a function has not been realized yet.

### DISCLOSURE OF THE INVENTION

A method for designing a light transmission device provided by the present invention has a metal thin film, and a rectangular aperture which is formed in a plane of the metal thin film, has a long side and a short side and makes light pass therethrough; and is characterized in that the short side has a dimension smaller than a wavelength of incident light, and the long side is determined to have such a dimension that a peak wavelength at which the transmittance of light passing through the rectangular aperture is maximal can be a predetermined value.

A switching element according to the present invention has a light transmission device designed by a method for designing the light transmission device according to the present invention, characterized in that the switching element changes a spectrum of transmitted light by changing a polarization direction of incident light with respect to the metal thin film.

A chemical sensor device according to the present invention is characterized in that the chemical sensor device includes: a light transmission device designed by the method of designing the light transmission device according to the present invention; a light source arranged on an entrance plane side of the light transmission device; and a device for detecting a spectrum of transmitted light, which is arranged on an exit plane side of the light transmission device.

An optical element according to the present invention having a metal thin film and an aperture array of a plurality of rectangular apertures formed in a plane of the metal thin film, characterized in that: a plurality of the rectangular apertures have such a dimension in a long side direction and a dimension in a short side direction as to be smaller than a wavelength of transmitting light and be common in the respective rectangular apertures; a plurality of the rectangular apertures is arranged at a long side direction array pitch along a long side direction of the rectangular apertures, and also are arranged at a short side direction array pitch along a short side direction of the rectangular apertures, which is different from the long side direction array pitch; and the long side direction array pitch is selected according to the dimension in the short side direction, and the short side direction array pitch is selected according to the dimension in the long side direction.

An refractive index sensor according to the present invention is characterized in that the refractive index sensor includes: a light source; the optical element according to claim 10, which is arranged on a light path and in a light traveling direction side with respect to the light source, and is composed so that the surface in the light source side closely contacts with an object to be measured; a polarization separating unit which separates a light having passed through the optical element into two polarized wave components, and is arranged on the light path and in the light traveling direction side with respect to the optical element; and two optical spectrum-detecting units which are arranged on the light path, in a light traveling direction side with respect to the polarization separating unit, and in two different places according to directions of the light, and determine a transmission spectrum of a light emitted from the polarization separating unit.

Further features of the present invention will become apparent from the following description of exemplary embodiments with reference to the attached drawings.

### BRIEF DESCRIPTION OF THE DRAWINGS

FIG. 1 is a conceptual diagram of a light transmission device according to the first embodiment of the present invention;

FIGS. 2A and 2B are conceptual diagrams for describing a relationship between a size of an aperture and a transmission spectrum;

FIGS. 3A and 3B are conceptual diagrams for describing a relationship between a length between poles of a magnetic dipole and a transmission spectrum;

FIGS. 4A, 4B, 4C and 4D are conceptual diagrams for describing a relationship between a shape of an aperture and a transmission spectrum;

FIG. 5 is an outside drawing of a color filter for an image sensor;

FIG. 6 is an outside drawing of a color filter for an image sensor, which is not affected by a polarized direction of light;

FIG. 7 is a block diagram of an optical switching element according to the second embodiment of the present invention;

FIGS. 8A and 8B are conceptual diagrams for describing a relationship among a dimension in a long side direction, a dimension in a short side direction and a transmission spectrum;

FIGS. 9A, 9B, 9C and 9D are views for describing transmission characteristics of an optical switching element;

FIG. 10 is a block diagram of a chemical sensor device according to the third embodiment of the present invention;

FIGS. 11A and 11B are conceptual diagrams for describing a relationship between a change of a dielectric constant occurring in an interface between a metal thin film and a medium, and a transmission spectrum;

FIGS. 12A, 12B and 12C are conceptual diagrams for describing a relationship between a shape of a rectangular aperture and a transmission spectrum;

FIG. 13 is a diagrammatic drawing for describing a relationship between a length of a rectangular aperture and a wavelength of a peak in a transmission spectrum;

FIG. 14 is a diagrammatic drawing for describing a relationship between a width of a rectangular aperture and a width of a peak in a transmission spectrum;

FIG. 15 is a diagrammatic block diagram of an optical element according to the present invention;

FIGS. 16A and 16B are views illustrating a spectrum of light having passed through an optical element in FIG. 15;

FIGS. 17A, 17B and 17C are views illustrating a structure of an example of a refractive index sensor according to the present invention and its effect;

FIG. 18 is a block diagram illustrating a modified example of a refractive index sensor according to the present invention;

FIGS. 19A, 19B and 19C are views illustrating a structure of an example of a refractive index sensor according to the present invention, and its effect;

FIGS. 20A, 20B, 20C and 20D are views illustrating a structure of an example of a refractive index sensor according to the present invention, and its effect; and

FIG. 21 is a block diagram of an example of a chemical sensor according to the present invention.

### BEST MODE FOR CARRYING OUT THE INVENTION

I. One aspect of the present invention is a method for designing a light transmission (filtering) device which uses a metal thin film that has a rectangular aperture thereon and causes localized plasmon resonance, and makes use of such properties of light that a transmission wavelength varies along with the change of a dimension in a long side direction in a rectangular aperture.

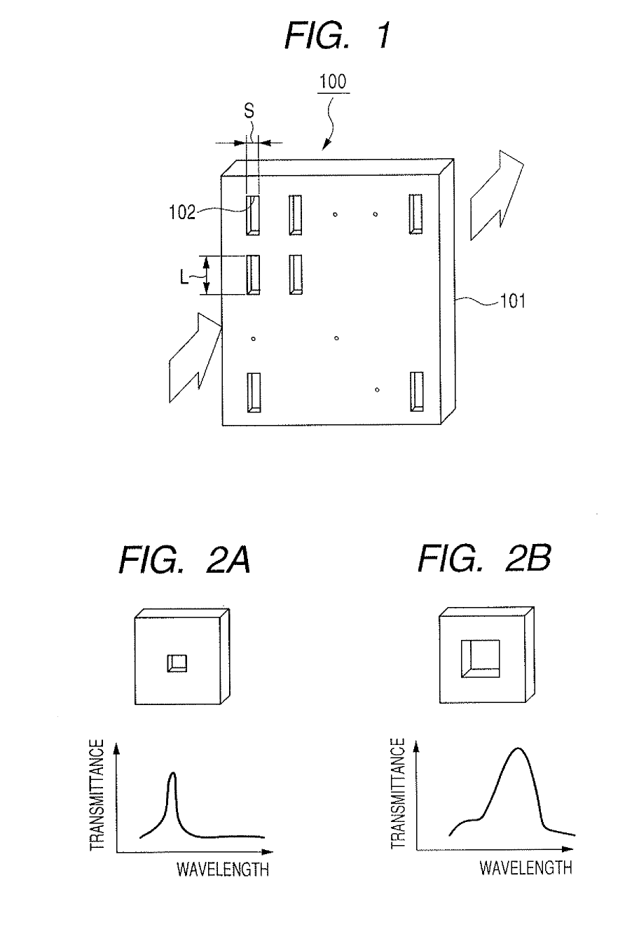

FIG. 1 illustrates a total structure of a light transmission device obtained by the present invention.

A light transmission device 100 has a metal thin film 101, and rectangular apertures 102 formed in a plane of the metal thin film 101.

A rectangular aperture 102 has a dimension of long side (L) (dimension in long side direction) and a short side dimension (S) (dimension in short side direction). The short side dimension (S) is the dimension equal to or shorter than a wavelength of transmitting light.

Though light incident on a rectangular aperture 102 passes through a rectangular aperture 102 due to localized plasmon resonance, the spectrum of the transmitted light has band-pass characteristics, so that a light transmission device according to the present invention can be used as a filter.

In the present invention, a dimension of long side (L) is selected according to a peak wavelength at which the transmittance of light passing through the rectangular aperture is maximal.

By thus varying (adjusting) a dimension of long side (L), the light transmission device can change a peak wavelength of transmitted light without greatly changing transmittance and a peak width.

As for one specific example of the numerics, when a rectangular aperture formed in a gold thin film with a thickness of 20 nm has a short side dimension of 50 nm, and dimension of long side of 100 nm and 200 nm, peak wavelengths are respectively about 750 nm and 1,000 nm.

In addition, a short side dimension (S) is selected according to a width of a peak at which the transmittance of light passing through the rectangular aperture is maximal. By thus varying (adjusting) a short side dimension (S), the light transmission device can change a peak width of transmitted light.

As for a specific example of the numeric, when a rectangular aperture has a dimension of long side of 200 nm, and short side dimensions of 50 nm and 100 nm, peak widths are respectively about 150 nm and 200 nm.

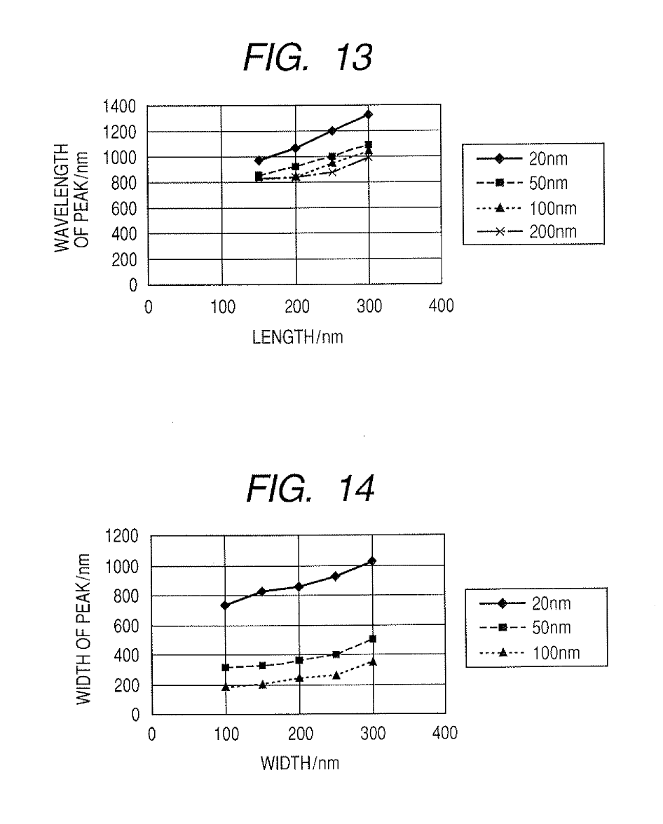

Here, a diagrammatic drawing in FIG. 13 illustrates a change of a peak wavelength when a length of a rectangular aperture having a width of 100 nm is changed in gold thin films having respective thicknesses of 20, 50, 100 and 200 nm.

Referring to the diagrammatic drawing, it is understood that when a rectangular aperture having a fixed width is formed in a metal thin film having a certain material quality and a fixed film thickness, the light transmission device can shift its peak wavelength to a long wavelength side by increasing a length of the rectangular aperture.

Accordingly, it is also understood with reference to the diagrammatic drawing that when it is required to obtain a transmission spectrum having a peak wavelength of 1,000 nm while using, for instance, a gold thin film having a thickness of 50 nm and having a rectangular aperture with a width of 100 nm formed therein, it is essential only to set a length of the rectangular aperture at 250 nm.

In addition, a diagrammatic drawing in FIG. 14 illustrates a change of peak width when a width of a rectangular aperture having a length of 300 nm is changed in gold thin films having respective thicknesses of 20, 50 and 100 nm.

Referring to the diagrammatic drawing, it is understood that when a rectangular aperture having a fixed length is formed in a metal thin film having a certain material quality and a fixed film thickness, the light transmission device can narrow its peak width by decreasing a width of the rectangular aperture.

Accordingly, it is also understood with reference to the diagrammatic drawing that when it is required to obtain a transmission spectrum having a peak width of 200 nm while using a gold thin film having a thickness of 100 nm and having a rectangular aperture with a length of 300 nm formed therein, it is essential only to set a width of the rectangular aperture at 150 nm.

In addition, referring to a diagrammatic drawing in FIG. 13, it is possible to shift a peak wavelength to a short wavelength side by increasing a thickness of a metal thin film when the metal thin film has a thickness in a range of 20 nm to 200 nm.

In addition, a value of the above described peak wavelength slightly varies with the material quality of a metal thin film. For instance, when a rectangular aperture with a length of 300 nm and a width of 100 nm is formed in a metal thin film with a thickness of 50 nm, the value for gold and silver is 1,100 nm, and the value for aluminum is 960 nm.

An electromagnetic wave with an appropriate wavelength projected to a metal can excite localized plasmon resonance on the metal. In order to make the electromagnetic wave effectively cause localized plasmon resonance, a metal thin film is preferably made from silver, gold or aluminum.

Localized plasmon resonance is a phenomenon which characteristically occurs in metal dots or an aperture having a size of a light wavelength or shorter, and originates in free electrons in a metal and the dielectric dispersion of the metal.

Localized plasmon resonance occurring in metal microparticles is a cause of coloring in stained glass as well, and the existence has been known since olden times. On the other hand, it has been recently revealed that the localized plasmon resonance occurs even in the case of a metal thin film having an aperture formed therein.

According to the above described Japanese Patent No. 3,008,931, it is observed that light anomalously passes through the aperture due to the localized plasmon resonance, and the aperture has band-pass characteristics.

Originally, an electromagnetic wave hardly passes through an aperture having a dimension equal to or shorter than the wavelength, because of being limited by diffraction limit.

However, the electromagnetic wave can pass through the aperture opened in a metal thin film in a form of plasmon, because localized plasmon is excited in the aperture.

The wavelength of plasmon resonance is determined by a shape of the aperture, so that the aperture makes only the light with the wavelength pass therethrough. In other words, the aperture of the metal thin film shows band-pass characteristics.

It has been known that the band-pass characteristics can be adjusted by changing a size of the aperture and an array pitch of the aperture.

It is essential only to increase an aperture size, in order to shift a peak wavelength of transmitted light to a long wavelength side. In contrast to this, it is essential only to decrease an aperture size, in order to shift the peak wavelength to a short wavelength side.

However, as is illustrated in FIG. 2B, when a size of a circular or square aperture increases, a peak width of transmitted light increases and peak intensity increases as well.

On the other hand, as is illustrated in FIG. 2A, when the size decreases, the peak width of transmitted light decreases and peak intensity decreases as well.

The present inventors consider the reason why a peak wavelength of transmitted light can be varied by adjusting a dimension in a long side direction of a rectangular aperture in the present invention, as will be now described below.

A component of polarization in a direction perpendicular to the major axis of the rectangular aperture out of light incident on the rectangular aperture excites localized plasmon existing on an inner wall of a long side of a rectangular aperture.

When considering an electromagnetic field formed by a change of a distribution of a localized plasmon charge excited at a rectangular aperture, the electromagnetic field is understood to be equivalent to an electromagnetic field formed by a magnetic dipole having its axis in a major axis direction of the rectangular aperture.

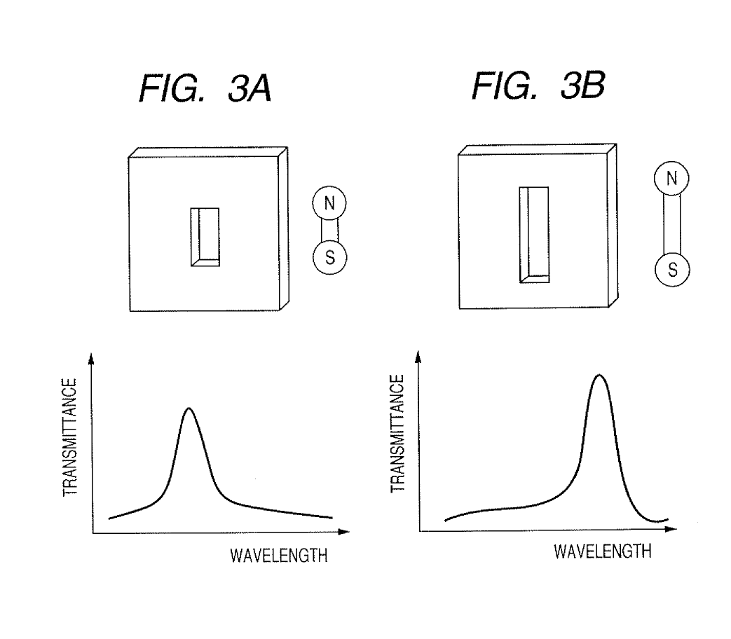

In other words, to adjust a dimension in a long side direction of a rectangular aperture is nothing but to adjust a length of a magnetic dipole. Accordingly, as is illustrated in FIGS. 3A and 3B, it can be understood that a resonance wavelength varies with a change of the length of the dipole.

When the size of an aperture is simply decreased, the transmittance of the light is also decreased, because the limitation of diffraction limit becomes strict. When the size of the aperture is increased, the limitation of the diffraction limit is alleviated, and an amount of a short wavelength component increases, which directly passes through the aperture without being affected by plasmon resonance as propagation light.

As a result of this, as described above, the change of the size of the aperture also causes the change of a peak intensity and peak width of the transmitted light.

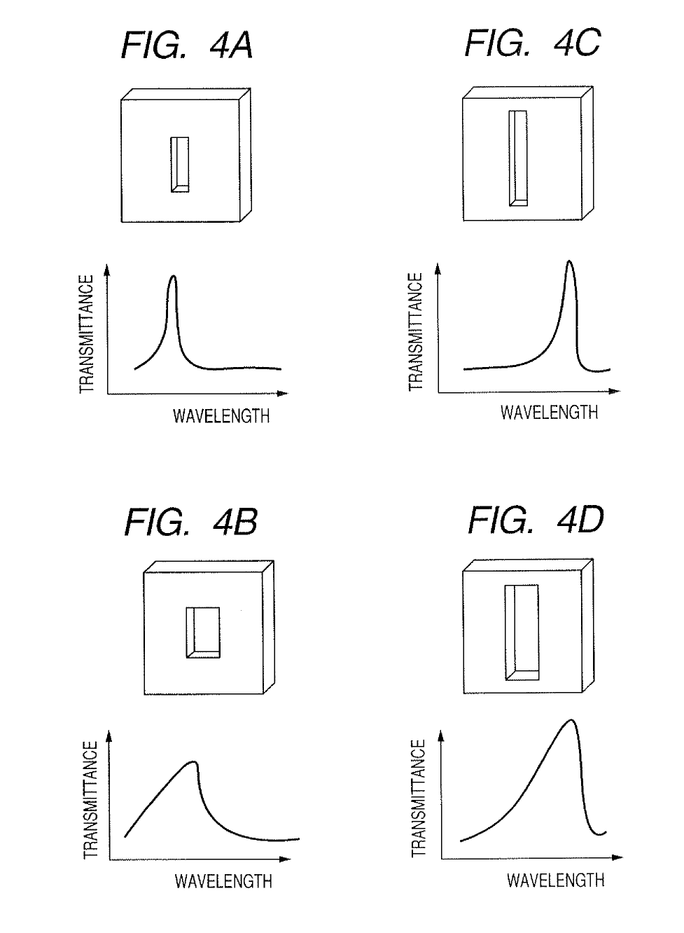

In the present invention, a peak wavelength of transmitted light can be changed by adjusting a dimension in a long side direction of a rectangular aperture, in other words, by changing only the length between poles of a magnetic dipole, without varying peak width and peak intensity, as is illustrated in FIGS. 4A to 4D. FIG. 4B illustrates a view in which a long side of the rectangular aperture in FIG. 4A is lengthened; FIG. 4C illustrates a view in which the short side is lengthened; and FIG. 4D illustrates a view in which the short side in FIG. 4B is lengthened or the long side in FIG. 4C is lengthened.

As described above, a dimension of long side of a rectangular aperture determines the peak wavelength of transmitted light having a component of polarization in a direction perpendicular to the major axis of the rectangular aperture out of light having irradiated the rectangular aperture.

When a short side dimension of the aperture is shorter than 1/10 of a wavelength of an irradiation light, the aperture causes a large propagation loss of localized plasmon therein which has been excited by a component of polarization in a major axis direction of the aperture, so that the light of a component of polarization in the direction perpendicular to a minor axis almost cannot passes through the aperture in comparison with the light of the component of polarization in the direction perpendicular to a major axis.

When a light irradiating a rectangular aperture is unpolarized, a peak wavelength of transmitted light having passed through the rectangular aperture is substantially equivalent to that obtained when the light having only the component of polarization in a direction perpendicular to a major axis has irradiated the rectangular aperture.

In the above description, a rectangular shape was described as an example of a shape of an aperture opened in a metal thin film, but the aperture has only to have a long side and a short side according to a concept in the present invention. Accordingly, for instance, a rectangle with a rounded corner, an oval and an ellipse are also included in the shape of the aperture in the concept according to the present invention.

A method for designing a light transmission device according to the present invention can control a wavelength of localized plasmon resonance which occurs on sides mainly in a major axis direction of a rectangular aperture, by adjusting the dimension in a long side direction of the rectangular aperture.

Accordingly, the method can make a light in an arbitrary wavelength range pass through a rectangular aperture with arbitrary intensity, by selecting a dimension in a long side direction of a rectangular aperture according to a desired peak wavelength of transmitted light.

In addition, the method can adjust a wavelength region in a spectrum of transmitted light without expanding a width of a transmission spectrum and without lowering the transmittance, by adjusting only a dimension in a long side direction.

### EMBODIMENT I-1

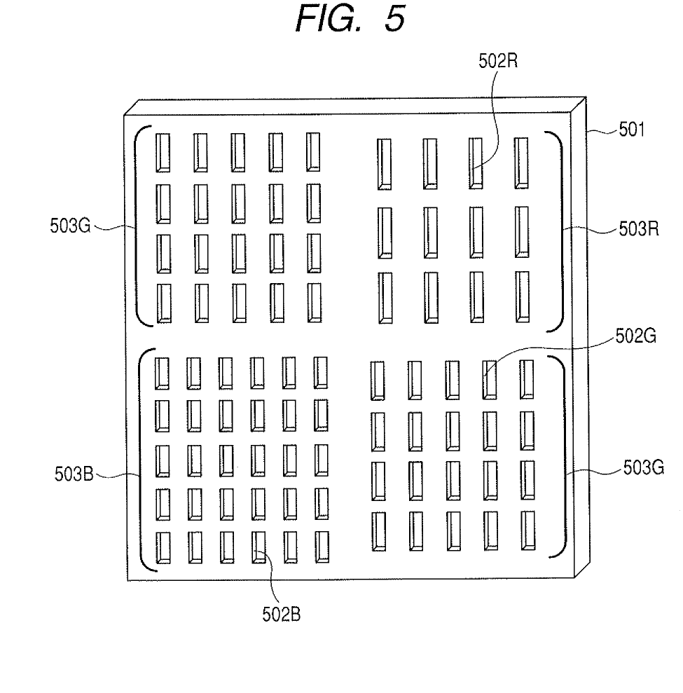

FIG. 5 illustrates a color filter for use in color separation, which is an example of a light transmission device obtained by using the present invention.

When light is incident on a rectangular aperture array 503 which is a set of rectangular apertures 502 formed in a metal thin film 501, localized plasmon is excited in an interface of a metal. Then, the light passes through the aperture in a form of plasmon, is united with propagation light on the back face, and transmits.

Transmitted light has a peak wavelength depending on a shape of a rectangular aperture 502, because of being affected by localized plasmon resonance. Rectangular apertures 502 are arranged in a two-dimensional array form, but may also be arranged in a one-dimensional array form. The rectangular aperture 502 includes a plurality of types of the rectangular apertures 502R, 502G and 502B, of which the dimension of long side are different from the others. A rectangular aperture array 503 includes rectangular aperture arrays 503R, 503G and 503B.

The rectangular aperture array in FIG. 5 can be used as a color filter for use in color separation of a two-dimensional image sensor element such as a CCD and a CMOS sensor.

A color filter for use in color separation is required to have three peak widths in a spectrum of transmitted light so that respective central wavelengths correspond to R (red), G (green) and B (blue) obtained from a color matching function, each color is not clouded, and each width of the peaks R, G and B is appropriately overlapped with each other.

Rectangular apertures 502R, 502G and 502B have respective functions as color filters of R, G and B.

The present light transmission device can determine a peak wavelength of transmitted light by a dimension in a major axis direction of the aperture, and a peak width by a length in a minor axis direction.

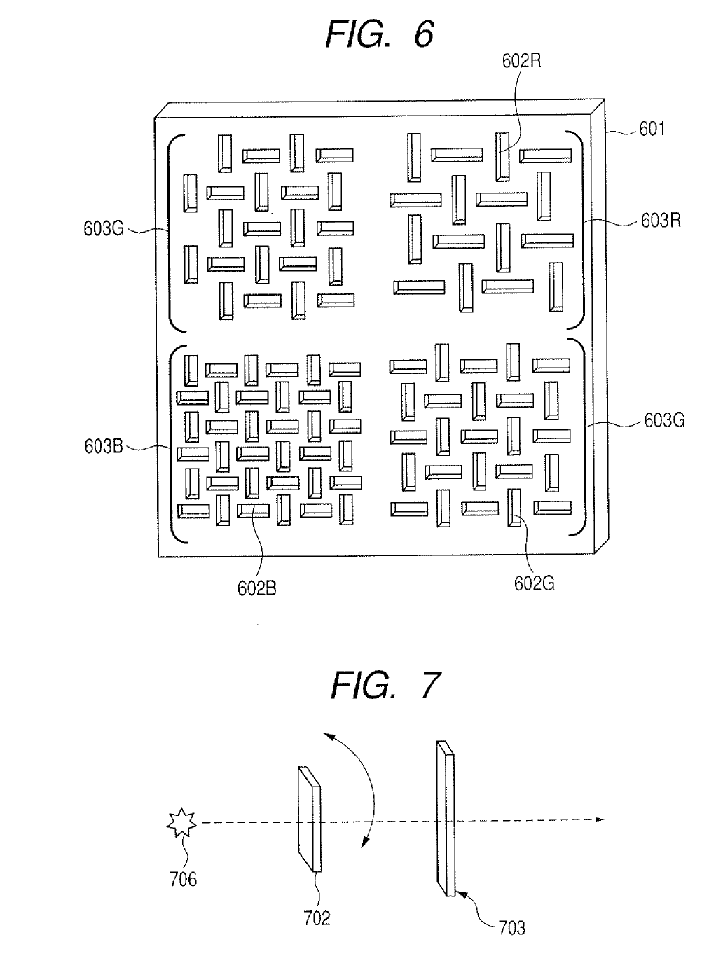

When it becomes a problem that the characteristics of the color filter is affected by a polarized direction of transmitted light, the color filter may have half of rectangular apertures arranged so as to tilt by 90 degrees with respect to the other rectangular apertures in a plane of a metal thin film, as illustrated in FIG. 6. In other words, the color filter may arrange the apertures of which the direction of a long side tilts by 90 degrees with respect to the other apertures in the plane of the metal thin film so as to coexist with the other apertures.

### EMBODIMENT I-2

FIG. 7 illustrates a conceptual diagram of an optical switching element which is an example of a light transmission device obtained by using the present invention.

The optical switching element polarizes white light emitted from a light source 706 by using a polarizer 702, and makes the polarized light pass through a rectangular aperture array 703. The optical switching element can change the chromaticness of transmitted light by polarizing the while light by using the polarizer 702.

In the present embodiment, a short side dimension of a rectangular aperture is determined so as not to be excessively small in comparison with a wavelength of irradiation light, and so as to give a necessary intensity of transmitted light even to a polarized light in a minor axis direction.

A rectangular aperture (not shown) in a rectangular aperture array 703 has characteristics of making polarized light pass therethrough in different manners depending on a polarization direction of the light.

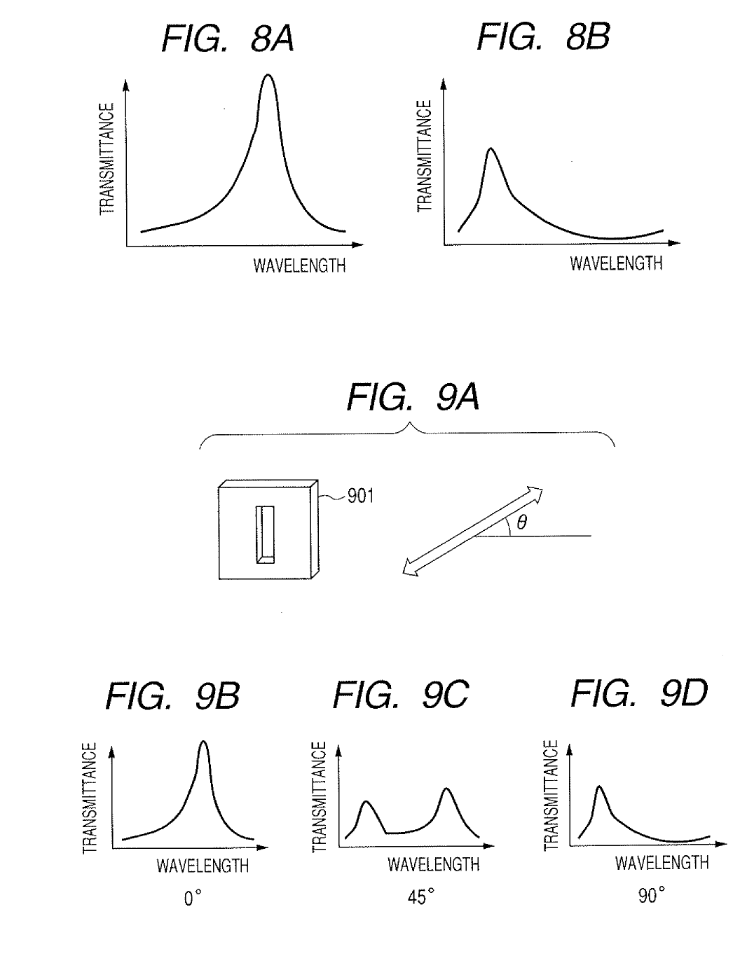

When light polarized in a minor axis direction is incident on the rectangular aperture, the transmitted light shows a peak in a long wavelength side corresponding to the major axis direction, as is illustrated in FIG. 8A.

When light polarized in a major axis direction is incident on the rectangular aperture, the transmitted light shows a peak in a short wavelength side corresponding to the minor axis direction, as is illustrated in FIG. 8B.

When polarized light having components in both of a minor axis direction and a major axis direction is incident on the rectangular aperture, the transmitted light shows overlapped characteristics of the polarized lights in each direction of the minor axis direction and the major axis direction.

Because the rectangular aperture has the above characteristics, the optical switching element can change a spectrum of transmitted light by changing a polarization direction e of incident light with respect to a metal thin film 901, and changes the chromaticness of transmitted light, as illustrated in FIGS. 9A to 9D.

In the present embodiment as well, a peak wavelength of transmitted light can be appropriately set by adjusting a dimension in a major axis direction of the aperture.

### EMBODIMENT I-3

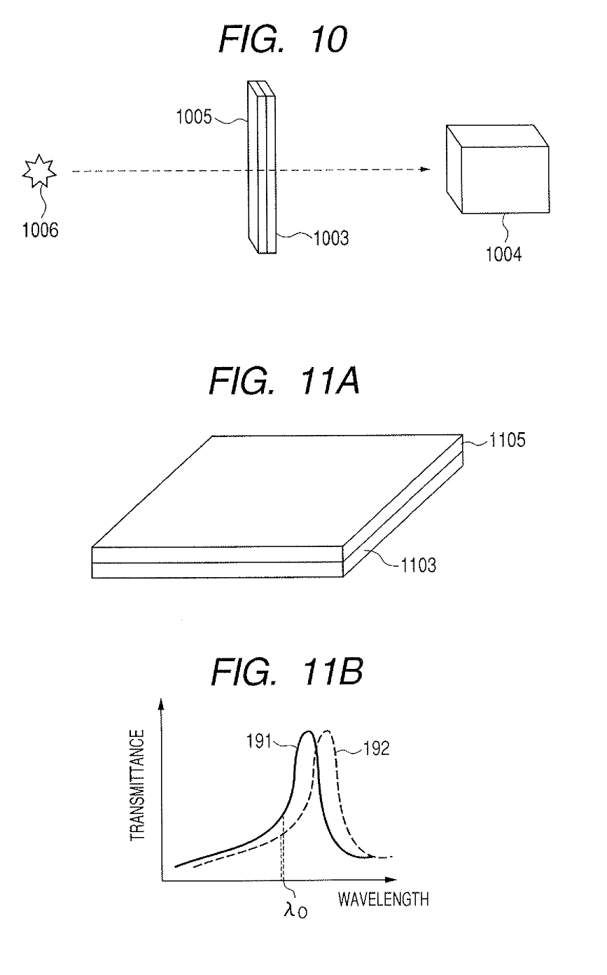

FIG. 10 illustrates a conceptual diagram of an example of a chemical sensor device by using the present invention.

The chemical sensor device makes a light source 1006 arranged on an incident plane side of a rectangular aperture array 1003 which is a light transmission device, project light toward the rectangular aperture array 1003, and makes a device 1004 for detecting a spectrum of the transmitted light, which is placed on the exit plane side of the rectangular aperture array 1003, receive the transmitted light.

An object 1005 to be measured is placed on a rectangular aperture array 1003 so as to closely contact with each other. The chemical sensor device makes a device 1004 for detecting the spectrum obtain a transmission spectrum, and detect a change in a peak wavelength or peak intensity of transmitted light to chemically sense a substance to be inspected.

The chemical sensor device can sense the substance 1005 to be inspected at high sensitivity, by making an incident plane of the rectangular aperture array 1003 previously adsorb a trapping substance (not shown) for trapping the substance 1005 to be inspected.

A dimension of long side and a short side dimension of a rectangular aperture (not shown) are formed so as to be smaller than a wavelength of light.

A spectrum of light having passed through a rectangular aperture is determined by a resonance condition in localized plasmon resonance.

The condition of localized plasmon resonance is determined by factors including: an element which forms a metal thin film; a three-dimensional shape of a rectangular aperture; and a dielectric constant of a substance with which a metal contacts on the interface. A wavelength of localized plasmon resonance varies with a value of the dielectric constant of the substance contacting with the surface of a rectangular aperture array, so that a peak wavelength of transmitted light also varies with the value of the dielectric constant.

Accordingly, the chemical sensor device can sense a substance 1105 contacting with a rectangular aperture array 1103, by measuring a change in a peak wavelength of transmitted light (FIGS. 11A and 11B).

The dielectric constant is specifically measured by the steps of:

at first, preparing a metal thin film provided with a rectangular aperture having a dimension of long side and a short side dimension;

next, making light incident on the rectangular aperture in a solution, in a state of not making an object to be measured contact with the surface of the metal thin film, and making the light pass through the rectangular aperture (referential step), to make the rectangular aperture provide a referential spectrum (continuous line 191 in FIG. 11B) that is a comparable object;

subsequently, making light incident on the rectangular aperture in a solution, in a state of making an object to be measured contact with the surface of the metal thin film, and making the light pass through the rectangular aperture (comparison step), to make the rectangular aperture provide a spectrum in which a peak wavelength of transmitted light is shifted by the presence of a measured object (dashed line 192 in FIG. 11B); and

then, determining the dielectric constant of the measured object by calculating a wavelength difference between the wavelength showing the maximum transmittance of transmitted light, which has been obtained in the referential step, and the wavelength showing the maximum transmittance of transmitted light, which has been obtained in the comparison step.

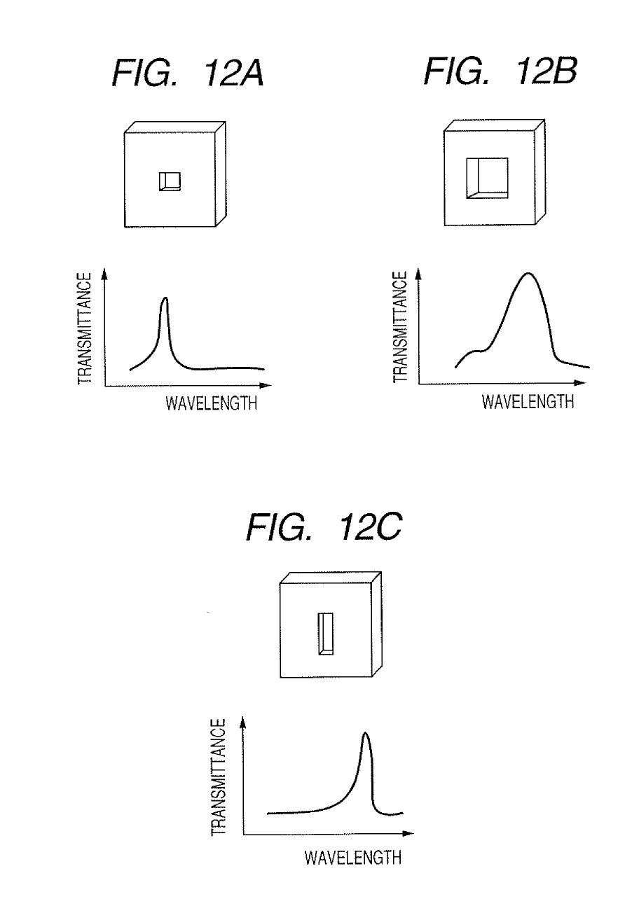

Incidentally, when the chemical sensor device performs sensing in a solution, the chemical sensor device needs to use wavelength for sensing except that absorbed by the solution. For instance, water has an absorption wavelength in a range from 950 to 1,050 nm and in a range of 1,400 nm or more. The chemical sensor device in the present embodiment can perform sensing while avoiding using the wavelength range to be absorbed by the solution, by adjusting a dimension in a long side direction of a rectangular aperture and thereby shifting the peak wavelength of transmitted light. A position of the peak wavelength of transmitted light can be shifted by a simple method of adjusting a size of the aperture. However, when the aperture size is made large as is illustrated in FIG. 12B in comparison with that in FIG. 12A, a peak width of transmitted light inevitably is expanded to lower detection sensitivity. The chemical sensor device in the present embodiment shifts the peak wavelength of transmitted light by adjusting a dimension in a long side direction of the rectangular aperture, as is illustrated in FIG. 12C. Thereby, the chemical sensor device can adjust a peak wavelength of transmitted light to another wavelength other than a wavelength range as to be absorbed by the solution, which is illustrated in FIG. 12A, without expanding a width of a peak of transmitted light, as is illustrated in FIG. 12B, and consequently can perform sensing at high sensitivity. As described above, a dimension in a long side direction of the aperture is selected while considering how a light of the peak wavelength is absorbed by a solution in a referential step. II. In the next place, another embodiment of the present invention will be described.

An optical element according to the present invention has a metal thin film, and an aperture array including a plurality of rectangular apertures formed in a plane of the metal thin film.

A plurality of the rectangular apertures are smaller than a wavelength of transmitting light, and has common dimension in a long side direction and a short side direction among respective rectangular apertures.

A plurality of rectangular apertures are arranged at a long side direction array pitch along a long side direction of the rectangular aperture and are arranged at a short side direction array pitch which is different from the long side direction array pitch, along the short side direction of the rectangular aperture.

The long side direction array pitch is selected corresponding to a dimension in a short side direction, and the short side direction array pitch is selected corresponding to a dimension in a long side direction.

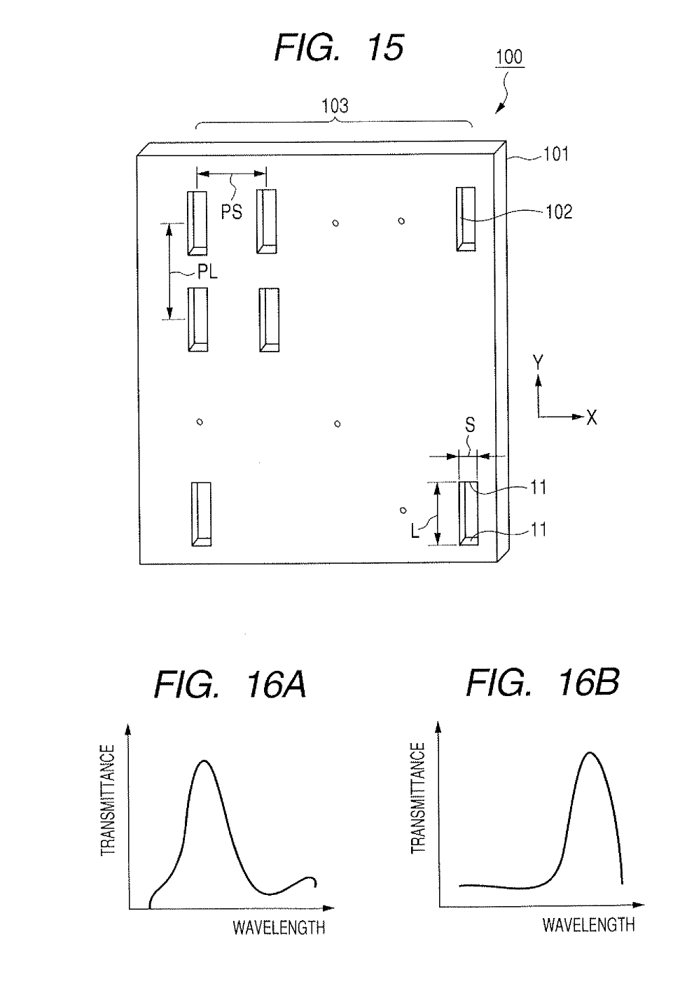

FIG. 15 illustrates a diagrammatic block diagram of an example for an optical element according to the present invention.

An optical element 100 has a metal thin film 101 and an aperture array 103 including a plurality of rectangular apertures 102 formed into a two-dimensional form in a plane of the metal thin film 101.

The optical element 100 according to the present invention makes use of such properties that an aperture array 103 including arrayed rectangular apertures 102 having anisotropy shows a different transmission spectrum depending on a polarized direction of incident light.

A material for a metal thin film 101 can be selected from general metals, but in order to give the metal thin film 101 a sharp resonance peak, such a metal like gold and silver or an alloy thereof as to strongly cause plasmon resonance is preferable.

A wavelength λspp of an excited plasmon resonance-peak varies with a type of a metal, so that when it is desired to use characteristics of an aperture array in a wavelength range of light, there is a method of selecting a material in addition to adjusting a shape of the aperture array.

An aperture array may be formed in free standing or formed on a transparent substrate.

A rectangular aperture 102 is formed so as to be smaller than a wavelength of light passing therethrough.

A rectangular aperture 102 has a dimension (L) in a long side direction and a dimension (S) in a short side direction, and the dimension (L) in the long side direction is longer than the dimension (S) in the short side direction. Accordingly, individual rectangular apertures 102 composing an aperture array 103 have anisotropy in a thin film plane as the characteristics of the aperture in itself.

As the aperture has such a shape, the aperture can make polarized light in an arbitrary direction in a plane pass therethrough to give transmitted light a particular spectrum. A dimension (L) in a long side direction and a dimension (S) in a short side direction are common among respective rectangular apertures 102.

Rectangular apertures 102 are arranged at a long side direction array pitch (PL) along a long side direction of the rectangular apertures 102.

Rectangular apertures 102 are arranged at a short side direction array pitch (PS) along a short side direction of the rectangular apertures 102.

A long side direction array pitch (PL) and a short side direction array pitch (PS) are defined by a center-to-center dimension of adjacent rectangular apertures 102. The short side direction array pitch (PS) is different from the long side direction array pitch (PL).

In an optical element 100 according to the present invention, a long side direction array pitch (PL) is selected according to a dimension (S) in a short side direction, and a short side direction array pitch (PS) is selected according to a dimension (L) in a long side direction.

The optical element 100 can show excellent polarization characteristics superior in S/N, particularly when adopting such a parameter of a structure that the polarization characteristics in a transmission spectrum due to individual apertures can be equal to the polarization characteristics due to an array pitch of an aperture array 103.

Specifically, when a light polarized in a long side direction is incident, a peak wavelength of light passing through a rectangular aperture 102 is decided by a dimension (S) in a short side direction.

Similarly, a peak wavelength of light passing through a rectangular aperture 102 is decided by a long side direction array pitch (PL).

Then, the dimension (S) in a short side direction and the long side direction array pitch (PL) are selected so that both peak wavelengths can be equal. On the other hand, when a light polarized in a short side direction is incident, a peak wavelength of light passing through a rectangular aperture 102 is decided by a dimension (L) in a long side direction.

Similarly, a peak wavelength of light passing through a rectangular aperture 102 is decided by a short side direction array pitch (PS). Then, the dimension (L) in a long side direction and the short side direction array pitch (PS) are selected so that both peak wavelengths can be equal.

When an aperture array having a different aperture dimension and a different array pitch in X- and Y-directions as described above is irradiated with so-called white light having a broad spectrum as a plane wave or a beam like a Gaussian beam, a plasmon wavelength λspp excited by light varies with a polarized direction.

The reason will be now described below. The above described X-direction and Y-direction are defined in FIG. 1.

At first, characteristics for a single rectangular aperture will be described. When light (electromagnetic wave) passes through the aperture, the aperture changes a quantity of light by limiting a cross-sectional area of the light flux.

When a dimension of an aperture is sufficiently larger than a wavelength of the light, there is linearity between an area of the aperture and a quantity of light. However, when the dimension of the aperture becomes smaller, and approximately equal to the wavelength of the light, a quantity of transmitted light is suddenly decreased. The phenomenon can be described to be caused by the diffraction limit of light.

As a result of this, normal propagation light almost cannot pass through an aperture having a size of the wavelength or smaller. However, when the incident light is once converted to plasmon on a metal surface, the light can pass though the aperture.

In order that the incident light is converted to plasmon on the metal surface, it is necessary for an aperture to have such a shape as to promote the excitation of the plasmon.

Then, a wavelength of plasmon excited by polarized light in an X-direction is different from that in a Y-direction caused by a difference between shapes of apertures in the X-direction and the Y-direction, and accordingly a peak wavelength of the transmitted light depends on a polarized direction.

The above described description relates to properties of a single rectangular aperture.

On the other hand, when circular apertures without anisotropy are periodically and anisotropically arranged, a peak wavelength of the transmitted light also depends on a polarized direction. In this case, even if the individual apertures do not vary the characteristics of light depending on a polarized direction of the light, but can vary the characteristics of light according to a polarized direction of the light due to the anisotropy of the array pitch.

In such a structure, surface plasmon resonance occurs on the periodic structure in an X-direction by being excited by a polarized light in the X-direction, and another surface plasmon resonance occurs on the periodic structure in a Y-direction by being excited by a polarized light in the Y-direction.

As described here, when array pitches of a periodically arrayed structure are different between an X-direction and a Y-direction, a wavelength of surface plasmon resonance for a polarized light in the X-direction is different from the wavelength of the surface plasmon resonance for a light polarized in the Y-direction.

The above description relates to properties affected by an array pitch of apertures.

These functions can be used alone, but an optical element in the present invention imparts anisotropy to an array pitch of rectangular apertures so as to realize higher polarization dependency.

Accordingly, the optical element can superposingly use the dependency of a peak wavelength of transmitted light on a single rectangular aperture and the dependency of the peak wavelength of transmitted light on an array pitch.

In other words, the optical element can enhance polarization characteristics, by adopting such parameters that the above described two peak wavelengths of transmitted light given by an individual rectangular aperture all match with the above described two peak wavelengths of transmitted light given by a periodical array respectively.

When a light polarized in an X-direction is incident on an aperture array composed as described above, plasmon is excited on an inner wall 11 in a direction perpendicular to the X-direction in an aperture, in other words, in the Y-direction of the aperture (cf. FIG. 15).

As a result of this, the transmitted light shows a transmission spectrum which reflects a length in a Y-direction of an aperture and a period (pitch) of the aperture in an X-direction, as is illustrated in FIG. 16A.

Similarly, the transmitted light shows a transmission spectrum which reflects a length in an X-direction of an aperture and a period (pitch) of the aperture in a Y-direction, as is illustrated in FIG. 16B.

In the above description, a rectangular shape was described as an example of a shape of an aperture opened in a metal thin film, but the aperture has only to have a long side and a short side according to a concept in the present invention. Accordingly, for instance, a rectangle with a rounded corner, an oval and an ellipse are also included in the shape of the aperture in the concept according to the present invention.

As described above, an optical element according to the present invention is an aperture array which gives different peak wavelengths to a transmitted light of a polarized light in an X-direction and a transmitted light of a polarized light in a Y-direction.

When a rectangular aperture has a dimension in a long side direction and a dimension in a short side direction, in other words, has a shape of a rectangle other than a square, a peak wavelength of plasmon resonance which is excited by incident light polarized in each direction varies with a difference between lengths of sides in each direction. Thereby, transmitted light acquires a different peak wavelength depending on a polarized direction of incident light.

Similarly, when apertures are arranged in a long side direction array pitch and in a short side direction array pitch different from the long side direction array pitch in each direction, a peak wavelength of plasmon resonance varies with these array pitches.

In the present invention, a long side direction array pitch is selected corresponding to a dimension in a short side direction, and a short side direction array pitch is selected corresponding to a dimension in a long side direction.

As a result of this, transmitting characteristics of incident light can be improved by correlating a peak wavelength of plasmon resonance, which is determined by a dimension of a rectangular aperture, with a peak wavelength of plasmon resonance, which is determined by an array pitch of the rectangular apertures.

Thereby, the filter can increase its S/N. The optical element also can set a peak wavelength of plasmon resonance, which depends on a long side direction array pitch and a dimension in a short side direction, independently from a peak wavelength of plasmon resonance, which depends on the short side direction array pitch and a dimension in a long side direction.

As a result of this, the filter can have a function of filtering light with different wavelengths.

### EMBODIMENT II-1

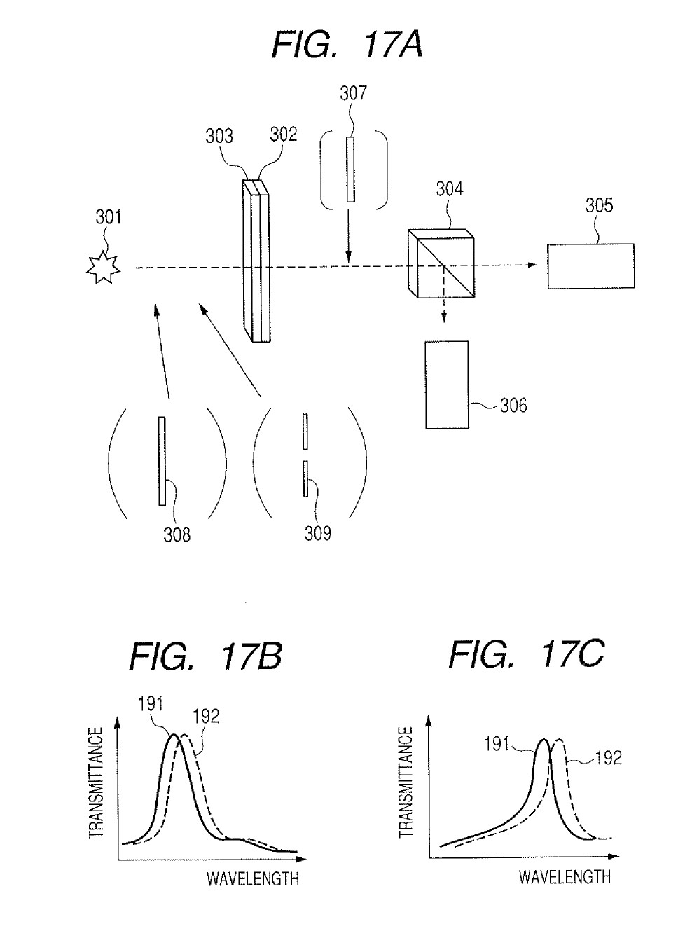

FIG. 17A illustrates a block diagram of a refractive index sensor which is one example in the present invention.

The refractive index sensor has: a light source 301; and an aperture array 302 which is the above described optical element, arranged on an optical path and in a light traveling direction side with respect to the light source 301.

An object 303 of which a refractive index is to be measured is arranged on the surface and apertures in a light source side of the aperture array 302, so as to closely contact with the aperture array 302.

Light emitted from a light source 301 is incident on an aperture array 302, and passes through the aperture array 302. A polarization beam splitter 304 for splitting a light having passed through the aperture array 302 into two polarized wave components is arranged on an optical path and in a light traveling direction side with respect to the aperture array 302.

Multichannel analyzers 305 and 306 for determining a transmission spectrum of light emitted from the polarization beam splitter 304 are arranged in two directions of separated light respectively on an optical path and in a light traveling direction side with respect to the polarization beam splitter 304.

The multichannel analyzers 305 and 306 acquire transmission spectrums of polarized light parallel to a paper plane and polarized light perpendicular to the paper plane respectively.

The refractive index sensor can simultaneously obtain two spectra each having a peak in a different wavelength, by treating two components of polarization perpendicular to each other in the same way.

The refractive index sensor having a structure according to the present embodiment can simultaneously measure transmission spectra for two components of polarization, and accordingly can easily track, for instance, a change of a refractive index of an object to be measured with respect to time.

The refractive index sensor may add another optical element on some midpoint in an optical path, as needed. For instance, it is considered to add a band-pass filter 307 to narrow a band width, to add an ND filter 308 to adjust a quantity of light, or to add an iris 309 to remove stray light.

It is also possible to acquire a spectrum by using a detection system including a spectroscope and a photodetector, instead of a detector for acquiring the whole spectrum as in the case of multichannel analyzers 305 and 306.

When a refractive index of an object 303 to be measured changes, which contacts with the surface of the aperture array 302, a wavelength of plasmon resonance occurring on the surface of an aperture array 302 changes.

As a result, a position of a transmission peak is shifted. FIG. 17B illustrates a spectrum of transmittance (continuous line), which is detected by an analyzer for a polarized light in an X direction when a refractive index of an object 303 to be measured is (n), and a spectrum of transmittance (dashed line), which is detected when the refractive index is (n+Δn).

FIG. 17C illustrates a spectrum of transmittance (continuous line), which is detected by an analyzer for a polarized light in a Y direction when a refractive index of an object 303 to be measured is (n), and a spectrum of transmittance (dashed line), which is detected when the refractive index is (n+Δn).

On the contrary, a refractive index of an object 303 to be measured can be known from a peak shift amount of a transmission spectrum, if the peak shift amount is determined.

Particularly, the refractive index sensor which independently measures peak shift amounts of two different transmission spectra as in the case of the present embodiment can improve S/N in the detection of a refractive index, and can enhance the accuracy of measurement.

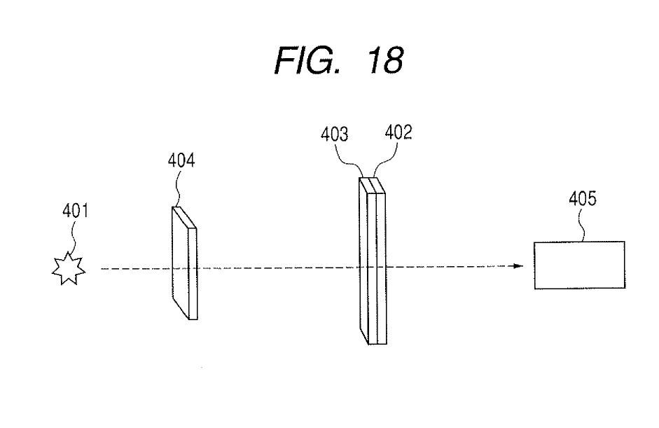

The refractive index sensor may also introduce a polarizer 404 right after a light source 401, as is illustrated in FIG. 18.

In this case, at first, a transmission spectrum is measured by making an object 403 to be measured closely contact with the surface in a light source side of an aperture array 402, irradiating the aperture array 402 with a light polarized in parallel to a paper plane, and making a multichannel analyzer 405 receive the transmitted light.

Next, a transmission spectrum is measured by rotating a polarizer 404 by 90 degrees, irradiating an aperture array 402 with a light polarized into a perpendicular direction to a paper plane, and making a multichannel analyzer 405 receive the transmitted light.

Thereby, spectra corresponding to two components of polarization can be obtained. The refractive index sensor in the present embodiment cannot measure two spectra simultaneously, but has such a merit as to be capable of reducing the number of components for the equipment.

### EMBODIMENT II-2

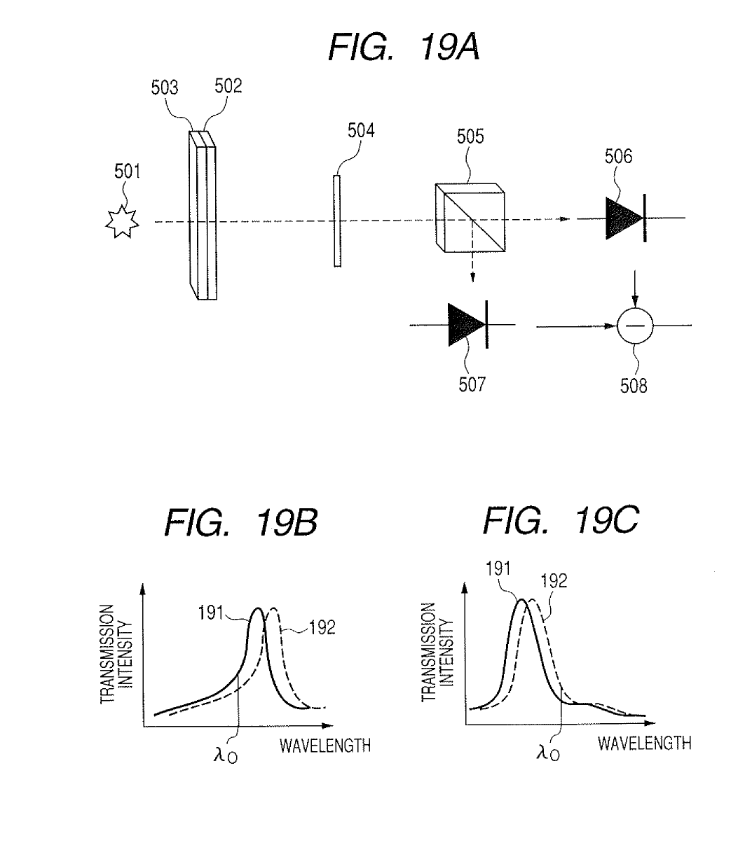

FIG. 19A illustrates a block diagram of a refractive index sensor which is another example in the present invention.

The refractive index sensor has: a light source 501; and an aperture array 502 which is the above described optical element, arranged on an optical path and in a light traveling direction side with respect to the light source 501.

Light emitted from a light source 501 is incident on an aperture array 502. An object 503 of which a refractive index is to be measured is arranged on the surface and apertures in a light source side of the aperture array 502, so as to closely contact with the aperture array 502.

A band-pass filter 504 is arranged on an optical path and in a light traveling direction side with respect to an aperture array 502. The band-pass filter 504 has a transmission wavelength at a point between two peak wavelengths of light having passed through the aperture array 502.

A polarization beam splitter 505 for splitting light having passed though the band-pass filter 504 into two polarized wave components is placed on an optical path and in a light traveling direction side with respect to the band-pass filter 504.

Two photodiodes 506 and 507 for receiving light emitted from the polarization beam splitter 505 are arranged in two directions of separated light respectively on an optical path and in a light traveling direction side with respect to the polarization beam splitter 505.

Furthermore, a computing unit 508 for calculating a difference between output signals of the photodiodes 506 and 507 is connected to the photodiodes 506 and 507.

A polarization beam splitter 505 splits a light into two polarized lights each in an X-direction and in a Y-direction. Then, a transmission spectrum (cf. FIG. 19B) of the polarized light in an X-direction and a transmission spectrum (cf. FIG. 19C) of the polarized light in a Y-direction can be observed at a transmission wavelength λₒ of a band-pass filter 504.

A signal with intensity at a transmission wavelength (observed wavelength) λₒ of a band-pass filter out of transmission spectra in an X-direction and a Y-direction can be obtained by making these transmitted lights incident onto two photodiodes 506 and 507.

When a refractive index of an object to be measured 503 arranged on an aperture array 502 increases from (n) to (n+Δn), and respective transmission wavelength peaks 191 (refractive index of (n)) in an X-direction and a Y-direction are shifted to 192 (refractive index of (n+Δn)) in a long wavelength side, the intensity of light received by a photodiode 506 decreases thereby (FIG. 19B), and the intensity of light received by a photodiode 507 increases (FIG. 19C).

The refractive index sensor can measure an object at higher sensitivity, by subtracting an output signal of a photodiode 507 from an output signal of the photodiode 506 with the use of a computing unit 508 to cancel a drifting noise component common to both polarized waves.

The refractive index sensor having such a structure can precisely measure an amount of change in a transmission spectrum without needing a spectroscope, and can determine an amount of change in a refractive index of an object to be measured 503.

Furthermore, a noise component can be effectively canceled by appropriate weighting before the subtraction.

### EMBODIMENT II-3

It is possible to employ a structure of using a plurality of band-pass filters, instead of arranging the band-pass filter 504 right before a polarization beam splitter 505 as in Embodiment II-2.

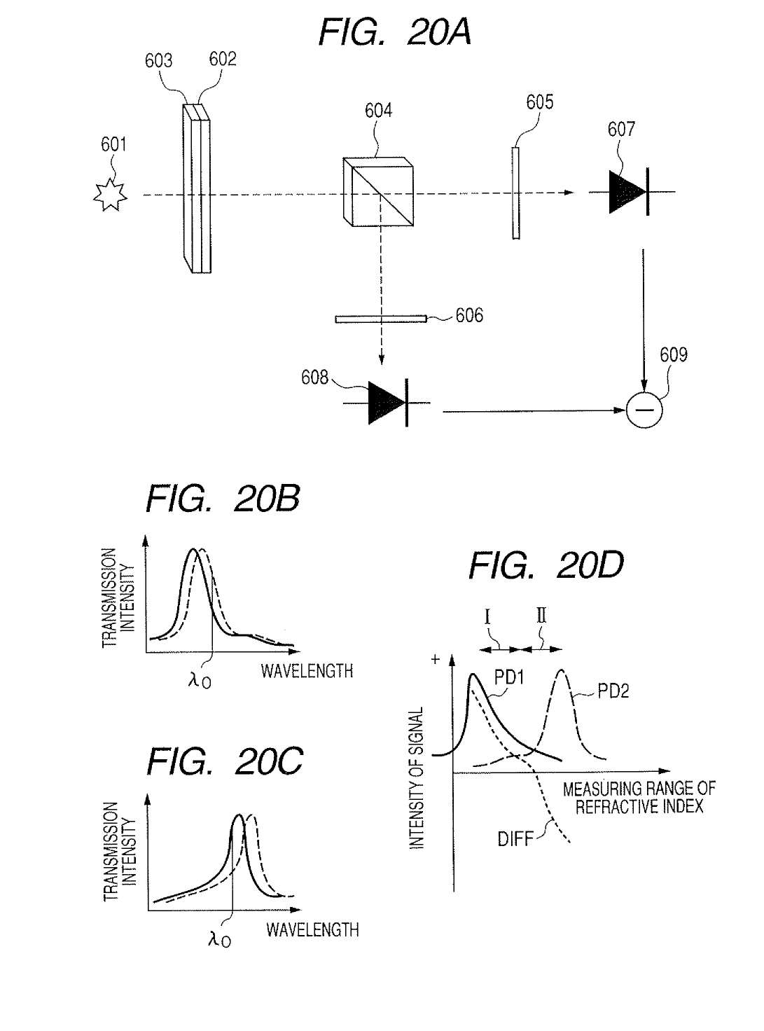

FIG. 20A illustrates a block diagram of a refractive index sensor according to Embodiment II-3 of the present invention.

The refractive index sensor has: a light source 601; and an aperture array 602 which is the above described optical element, arranged on an optical path and in a light traveling direction side with respect to the light source 601.

An object 603 of which a refractive index is to be measured is arranged on the surface and apertures in a light source side of the aperture array 602, so as to closely contact with the aperture array 602.

A polarization beam splitter 604 for splitting a light having passed through the aperture array 602 into two polarized wave components is arranged on an optical path and in a light traveling direction side with respect to the aperture array 602.

Two band-pass filters 605 and 606 are arranged respectively in two directions of split light on an optical path and in a light traveling direction side with respect to a polarization beam splitter 604.

Two photodiodes 607 and 608 for receiving light having passed through band-pass filters 605 and 606 are arranged on an optical path and in a light traveling direction side with respect to the band-pass filters 605 and 606.

Furthermore, a computing unit 609 for calculating a difference between output signals of the photodiodes 607 and 608 is connected to the photodiodes 607 and 608.

As described above, in the present embodiment, a band-pass filter 605 is inserted in between a polarization beam splitter 604 and a photodiode 607, and a band-pass filter 606 is inserted in between the polarization beam splitter 604 and the photodiode 608.

A transmission wavelength of the band-pass filter 605 does not necessarily correspond to a transmission wavelength of the band-pass filter 606.

It is preferable to set a transmission wavelength λₒ of a band-pass filter 605 at a shoulder in a long wavelength side of a peak as illustrated in FIG. 20B so that a change of the transmission intensity of a light having passed through the band-pass filter 605 can be maximal.

At the same time, a transmission wavelength λₒ of a band-pass filter 606 is preferably set at a shoulder in a short wavelength side of a peak as is illustrated in FIG. 20C so that a change of the transmission intensity of a light having passed through the band-pass filter 606 can be maximal.

A combination of such band-pass filters 605 and 606 is preferable for measuring a change in a refractive index of an object to be measured at high accuracy.

Alternatively, it is also possible to select wavelengths of two band-pass filters 605 and 606 as is illustrated in FIG. 20D.

Specifically, in a range I of a change in a refractive index, an output of mainly a photodiode 607 (indicated as PD1 in the drawing) largely changes, whereas the change of the output of the photodiode 608 (indicated as PD2 in the drawing) is small.

When a change in a refractive index becomes large to enter a range II, an output mainly from a photodiode 608 largely changes, and the change of the output from the photodiode 607 is small.

In this case, the refractive index sensor can obtain an effect of capable of measuring a refractive index in a wider range, by determining a difference (indicated as “DIFF” in the drawing) between output signals of two photodiodes 607 and 608. The refractive index sensor can enhance the linearity of a sensor output, by adjusting weighting before subtraction.

### EMBODIMENT II-4

A chemical sensor is realized by adding some factors to a structure of the above described refractive index sensor.

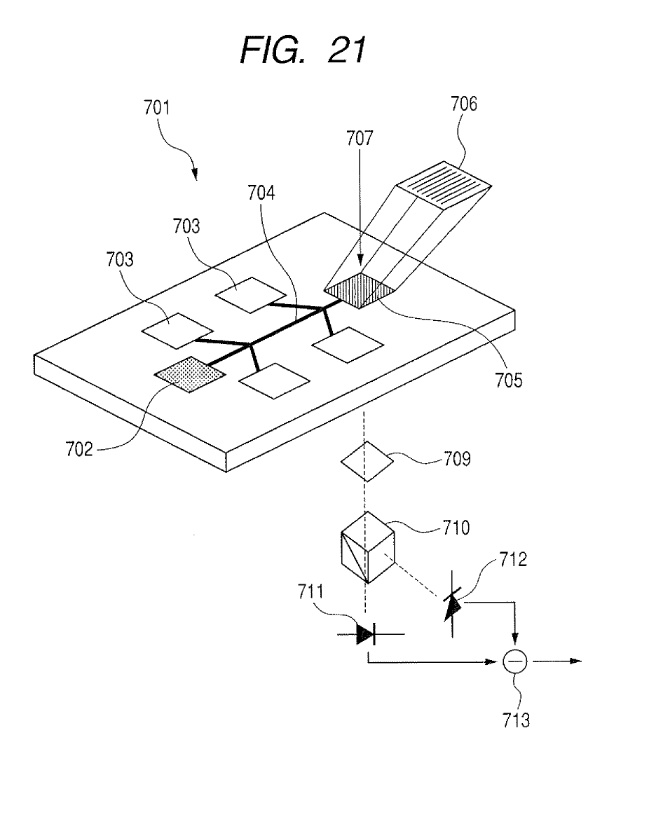

FIG. 21 illustrates an example of integrating a refractive index sensor into a microchemical analysis system (also referred to as μ-TAS: Micro Total Analysis System or Lab-on-a-chip), which is the above described chemical sensor.

In a microchemical analysis system 701 illustrated in FIG. 21, a liquid to be examined is injected from a sample liquid injection section 702, passes through a channel 704, reacts with a reaction liquid injected from a reaction liquid injection section 703, and then arrives at a detecting section 705.

In a detecting section 705, an aperture array 706 is installed which detects a liquid to be examined based on a principle of the present invention, and which is enlarged and illustrated in the drawing.

A liquid to be examined is supplied to an aperture array 706 so as to closely contact with the aperture array 706, and reacts with a sensor material on the surface of the aperture array 706 and inside the aperture.

An excitation light 707 emitted from a light source irradiates the detecting section 705, and passes through an aperture array 706. The transmitted light 708 passes through a band-pass filter 709, and is polarized and split by a polarization beam splitter 710.

Photodetectors 711 and 712 detect optical intensities of respective polarized lights. The refractive index of the liquid can be known from these signals as in the case of Embodiment II-2. The refractive index tells the concentration of an analyte in a liquid to be examined.

In order to detect an object to be measured (substance to be detected) according to the present embodiment, the substance to be detected needs to approach to an active region (vicinity of an aperture array).

Accordingly, the chemical sensor can measure a substance to be detected at higher sensitivity, by previously connecting a sensor material to selectively adsorb a substance to be detected to an aperture array.

The sensor material has only to be a substance which causes one or more changes among such changes of a film thickness, of a refractive index and of an absorption spectrum as to be caused by a reaction between the sensor material and a substance to be examined.

When the chemical sensor measures such an object to be measured as to cause a change of a film thickness on the surface of an array, and when the film thickness is small, the chemical sensor mainly measures a refractive index of a solution, because the object to be measured occupies a little proportion of volume in an active region, so that the aperture array almost does not sense a refractive index of the object to be measured.

When the film thickness becomes large, the chemical sensor mainly measures a refractive index of the object to be measured, because the object to be measured occupies a higher proportion of volume in an active region.

In this case, the chemical sensor measures a change of a film thickness, which is an effective change of a refractive index in an active region.

By making use of the mechanism, it can be sensed whether a substance absorbed or precipitated on a metal surface of an aperture array exists in an object to be measured or not, or the concentration of the substance can be sensed, and such a substance as to change its refractive index due to a chemical change can be sensed.

There are a batch system and a channel system in chemically sensing an object. When the channel system is employed, the system further exerts a function of transporting a substance to be detected to an active region (vicinity of the surface of an aperture array).

A chemical sensor having a developed form of the structure can sense a biomaterial by using such properties of the biomaterial as to be selectively and specifically absorbed.

The chemical sensor can sense the biomaterial by previously connecting such a sensor material as to selectively and specifically absorb a substance to be detected, with an aperture array; making the substance to be detected be adsorbed to the vicinity of an aperture array; and measuring a change in a transmission spectrum originating from one or more changes among the change of a film thickness, the change of a refractive index and the change of an absorption spectrum, which are caused by the above absorption reaction.

A material to be selectively and specifically absorbed has properties of causing an antigen-antibody reaction or causing hybridization with DNA, so that disease can be diagnosed by sensing the substances.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-052157 filed Feb. 28, 2006 and No. 2006-052226 filed Feb. 28, 2006, which are hereby incorporated by reference herein in their entirety.

1. A method for designing a light transmission device having
a metal thin film, and
a rectangular aperture which is formed in a plane of the metal thin film, has a long side and a short side and makes light pass therethrough, characterized in that
the short side has a dimension smaller than a wavelength of incident light, and
the long side is determined to have such a dimension that a peak wavelength at which the transmittance of light passing through the rectangular aperture is maximal can be a predetermined value.

2. A method for designing the light transmission device, characterized in that the method determines the dimension of the short side while considering a width of a peak at which the transmittance of light passing through the rectangular aperture is maximal.

3. The method for designing the light transmission device according to claim 1, characterized in that the method determines the dimension of the long side while setting a film thickness of the metal thin film and a dimension of the short side at a fixed value.

4. The method for designing the light transmission device according to claim 1, characterized in that a polarized direction of the incident light is parallel to a direction of the short side.

5. The method for designing the light transmission device according to claim 1, characterized in that the method arranges the rectangular apertures into a one-dimensional or two-dimensional array form.

6. The method for designing the light transmission device according to claim 5, wherein the rectangular apertures are formed of a plurality of types of the rectangular apertures having different dimensions in the long sides.

7. The method for designing the light transmission device according to claim 5, wherein the rectangular apertures are arranged so that rectangular apertures having a direction in the long sides inclined in 90 degrees in a plane of the metal thin film coexist with rectangular apertures having other directions.

8. An optical switching element having the light transmission device designed by a method for designing the light transmission device according to claim 1, characterized in that the optical switching element changes a spectrum of transmitted light by changing a polarization direction of incident light with respect to the metal thin film.

9. A chemical sensor device characterized in that the chemical sensor device comprises:
a light transmission device designed by the method of designing the light transmission device according to claim 1;
a light source arranged on an entrance plane side of the light transmission device; and
a device for detecting a spectrum of transmitted light, which is arranged on an exit plane side of the light transmission device.

10. An optical element having
a metal thin film and
an aperture array comprising a plurality of rectangular apertures formed in a plane of the metal thin film, characterized in that:
a plurality of the rectangular apertures have such a dimension in a long side direction and a dimension in a short side direction as to be smaller than a wavelength of transmitting light and be common in the respective rectangular apertures;
a plurality of the rectangular apertures are arranged at a long side direction array pitch along a long side direction of the rectangular apertures, and also are arranged at a short side direction array pitch along a short side direction of the rectangular apertures, which is different from the long side direction array pitch; and
the long side direction array pitch is selected according to the dimension in the short side direction, and the short side direction array pitch is selected according to the dimension in the long side direction.

11. The optical element according to claim 10, wherein the dimension in the short side direction and the long side direction array pitch are selected so that a peak wavelength of light passing though the rectangular aperture, which is determined by the dimension in the short side direction, can be equal to the peak wavelength of the light passing through the rectangular aperture, which is determined by the long side direction array pitch, when the light polarized in the long side direction is incident.

12. The optical element according to claim 10, wherein the dimension in the long side direction and the short side direction array pitch are selected so that a peak wavelength of light passing though the rectangular aperture, which is determined by the dimension in the long side direction, can be equal to the peak wavelength of the light passing through the rectangular aperture, which is determined by the short side direction array pitch, when the light polarized in the short side direction is incident.

13. A refractive index sensor comprising:
a light source;
an optical element according to claim 10, which is arranged on a light path and in a light traveling direction side with respect to the light source, and is composed so that the surface in the light source side closely contacts with an object to be measured;
a polarization separating unit which separates a light having passed through the optical element into two polarized wave components, and is arranged on the light path and in the light traveling direction side with respect to the optical element; and
two optical spectrum-detecting units which are arranged on the light path, in a light traveling direction side with respect to the polarization separating unit, and in two different places according to directions of the light, and determine a transmission spectrum of a light emitted from the polarization separating unit.
